(19) United States
(12) Patent Application Publication
(10) Pub. No.: US 2008/0223503 A1
(43) Pub. Date: Sep. 18, 2008

(54) MELT GLUE FIXING METHOD AND ELECTRICAL CONNECTOR USING THE SAME

(75) Inventor: Ted JU, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD., Anloku (TW)

(21) Appl. No.: 12/044,429

(22) Filed: Mar. 7, 2008

(30) Foreign Application Priority Data
Mar. 15, 2007 (CN) 200710089204.7

(51) Int. Cl. B32B 1/06; A47G 29/00

(52) U.S. Cl. 156/81; 248/205.3

(57) ABSTRACT

The invention provides a melt glue fixing method for fixing a terminal in the passageway of the insulating base. A glue blocking device is used to let a melted material flow toward a designated area during heating. Thus, the resulting structure will have a better fixing effect. An electrical connector based on the invention includes an insulating base with a plurality of passageways and a terminal accepted in the passageway. The insulating base and the terminal are fixed via a melt glue fixing structure, and the melt glue fixing structure has a shape which can increase the fixing effect. In the melt glue fixing method and the electrical connector using this method according to the invention, the melted material can flow toward a designated area due to the glue-blocking device. The resulting structure has a better fixing effect, thus, the terminal can be effectively fixed on the insulator.

### CROSS-REFERENCE TO RELATED APPLICATIONS

This non-provisional application claims priority under 35 U.S.C. §119(a) on Patent Application No. 200710089204.7 filed in China on Mar. 15, 2007, the entire contents of which are hereby incorporated by reference.

### BACKGROUND OF THE INVENTION

1. Field of the Invention

The present invention relates to a melt glue fixing method and an electrical connector using the melt glue fixing method.

2. Description of the Prior Art

In general, an electrical connector includes an insulating base having a plurality of passageways and a plurality of terminals received in the passageways, respectively. In order to securely retain the terminal in the insulating base, the terminals usually define barbs for engaging with the insulating base. The mode is simple and easy to be practiced, but the walls of the passageways of the insulating base are accordingly damaged. This damage will not hugely affect the electrical connector with larger terminal intervals. However, with the miniaturization of electrical devices, the terminal interval is scaling down, and the walls of the passageways of the insulating base are getting thinner. Thus, the drawback of barb fixing mode becomes gradually obvious at present; it cannot meet the needs of the new type electrical connector.

For the time being, a mode of using a melt glue to fix two objects has been provided. In this fixing mode, the melted plastic can freely flow, which causes poor strength of the fixing structure of the cooled melt glue. Especially when the mode is used for fixing the insulating base and the terminal, only a thin layer of melt glue can be formed, so the insulating base and the terminal cannot be effectively fixed.

Therefore, it is needed to design a new type of melt glue fixing method and an electrical connector to solve the above mentioned problems.

### SUMMARY OF THE INVENTION

The goal of the present invention is to provide a melt fixing method which can effectively fix a terminal in an insulating base.

Next goal of the present invention is to provide a glue blocking device which can be used to fix a terminal in an insulating base.

Another goal of the present invention is to provide an electrical connector which can effectively fix a terminal in the insulating base.

In order to reach the above goals, the melt glue fixing method based on the invention comprising steps of: providing an insulating base having a plurality of passageways, a protruding portion disposed between the adjacent passageways; providing a plurality of terminals disposed in the passageways; providing a glue blocking device for forming a designated area; heating the protruding portion of the insulating base to form a melted material; making the melted material flow toward the designated area; and cooling the melted material to fix the terminals in the passageways of the insulating base.

In order to reach the above goals, a glue-blocking device is provided for fixing a terminal in an insulating base, the insulating base having a plurality of passageways, a protruding portion disposed between the adjacent passageways, comprising: a stopping portion extending along a transverse direction defined by the terminal and near two ends of the protruding portion; in a longitudinal direction defined by the terminal, the melted material only flows to the position of the stopping portion; and a separating block extending along a longitudinal direction defined by the terminal and corresponding to a middle position of the terminal; in a transverse direction defined by the terminal, the melted material only flows toward the connecting area of the terminal and the protruding portion and smaller areas nearby.

In order to reach the above goals, the electrical connector based on the invention includes an insulating base with a plurality of passageways and at least one terminal accepted in the passageways. The insulating base and the terminal are fixed via a melt glue fixing structure, and the melt glue fixing structure has a shape which can increase the fixing effect.

In the melt glue fixing method and the electrical connector using this method according to the invention, the melted material can flow toward a designated area due to the glue-blocking device. The resulting structure has a better fixing effect, thus, the object (the terminal) can be effectively fixed on the insulator.

### BRIEF DESCRIPTION OF THE APPENDED DRAWINGS

FIG. 1 is a three-dimensional decomposition diagram of the electrical connector based on the invention.

FIG. 2 is a diagram of the upper layer terminal shown in FIG. 1.

FIG. 3 is a diagram of the insulating base shown in FIG. 1 before using the melt glue.

FIG. 4 is a diagram of the glue-blocking device when the insulating base and the terminal are fixed by the melt glue in the electrical connector.

FIG. 5 is a diagram of the glue-blocking device shown in FIG. 4 blocking at the two ends of the melt glue area.

FIG. 6 is a diagram of the melt glue device and the electrical connector after the melt glue is used.

FIG. 7 is an assembly diagram of the insulating base and the terminal after the melt glue is used.

FIG. 8 is a cross-sectional view of the electrical connector after the terminal is fixed on the insulating base.

FIG. 9 is a partial cross-sectional view of the melt glue fixing structure when the cross-section of the melt glue fixing structure is a rectangle.

FIG. 10 is a partial cross-sectional view of the melt glue fixing structure when the cross-section of the melt glue fixing structure is a triangle.

FIG. 11 is a partial cross-sectional view of the melt glue fixing structure wedged with the terminal.

FIG. 12 is a three-dimensional assembly diagram of the electrical connector after the melt glue is used in the second embodiment based on the invention.

FIG. 13 is a three-dimensional decomposition diagram of FIG. 12.

FIG. 14 is a diagram of the electrical connector when the protruding portion of the electrical connector is not forced by the external force.

FIG. 15 is a partial enlarged diagram of FIG. 14.

FIG. 16 is a cross-sectional view of the insulating base of the electrical connector in the second embodiment based on the invention.

FIG. 17 is a diagram of the electrical connector after the protruding portion of the electrical connector is forced by the external force.

FIG. 18 is a partial enlarged diagram of FIG. 17.

FIG. 19 is a diagram of the terminal of the electrical connector in the second embodiment based on the invention.

FIG. 20 is a partial diagram of the insulating base of the electrical connector in the third embodiment based on the invention.

FIG. 21 is a diagram of the terminal of the electrical connector in the third embodiment based on the invention.

### DETAILED DESCRIPTION OF THE INVENTION

The melt glue fixing method and the electrical connector using the melt glue fixing method based on the embodiments of the present invention can be further illustrated with the following embodiments together with the appended drawings.

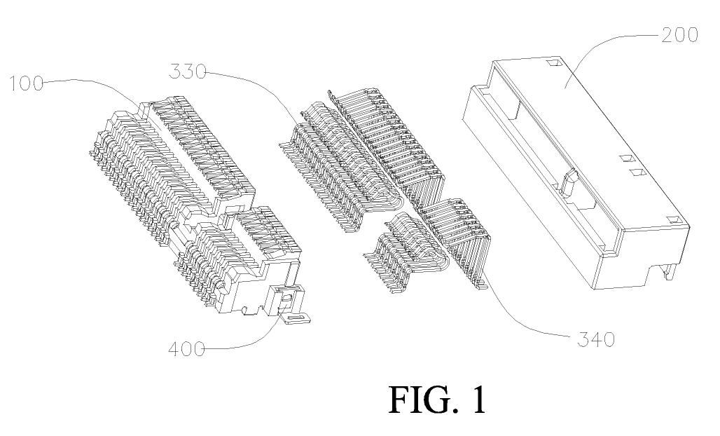

The melt glue fixing method is explained by the following example of an electrical connector, as shown in FIG. 1. The electrical connector includes an insulating base 100 with a plurality of passageways, two rows (an upper row and a lower row) of terminals 330, 340 received in the passageways, an insulating housing 200 covering the insulating base 100, and a fixing piece 400 used for fixing the insulating base 100 and a circuit board. Each of the terminals is fixed to the insulating base 100 via a melt glue fixing method. The melt glue fixing method in the embodiment will be described in detail by the following example of the upper row of terminals 330.

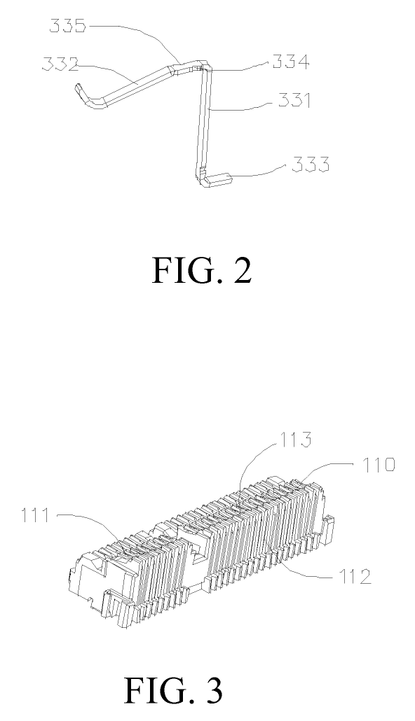

FIG. 2 shows one of the upper row of terminals 330. The terminal includes a body portion 331, a connecting portion 332 and a soldering portion 333 at the two sides of the body portion 331. A first hollow portion 334 and a second hollow portion 335 are interlaced on the connecting portion 332.

FIG. 3 shows a three-dimensional diagram of the insulating base 100 before the melt glue is used. The insulating base 100 includes a plurality of upper passageways 111 and a plurality of back passageways 112. The upper passageways 111 are used for receiving the connecting portion 332 of the upper row of terminals 330. The back passageways 112 are used for receiving the body portion 331 of the upper row of terminals 330. The protruding portion 113 on the back end of the upper passageways 111 is deposed between the upper passageways 111. The top of the protruding portion 113 is the melt glue area. The back passageways 112 have a similar structure on its lower end. Because its melt fixing method is the same with that of the upper passageways 111, it is introduced by the following example of the melt glue fixing of the protruding portion 113 between the upper passageways and the connecting portion 332 of the terminal.

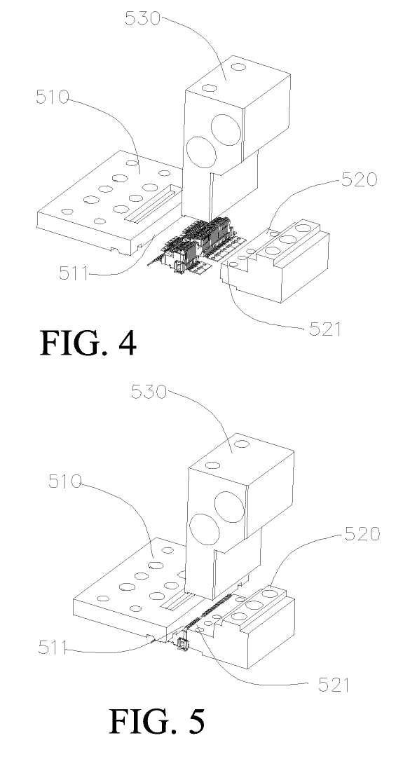

FIGS. 4˜7 show the steps of the melt glue fixing. Before the melt glue is used, the upper row of terminals 330 is disposed in the corresponding passageway. During the process of melt glue fixing, a front blocking device 510, a back blocking device 520, and a melt glue device 530 are needed. The front blocking device 510 and the back blocking device 520 have a front blocking portion 511 and a back blocking portion 521 respectively. Both the front blocking portion 511 and the back blocking portion 521 extend along the terminal transversely, as shown in FIG. 4.

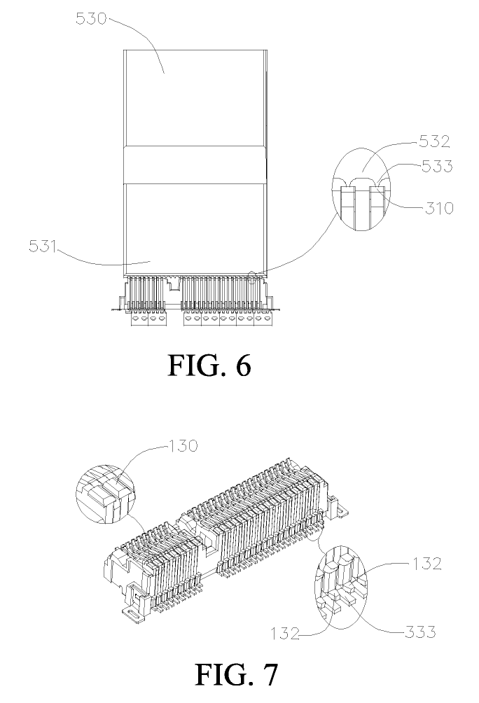

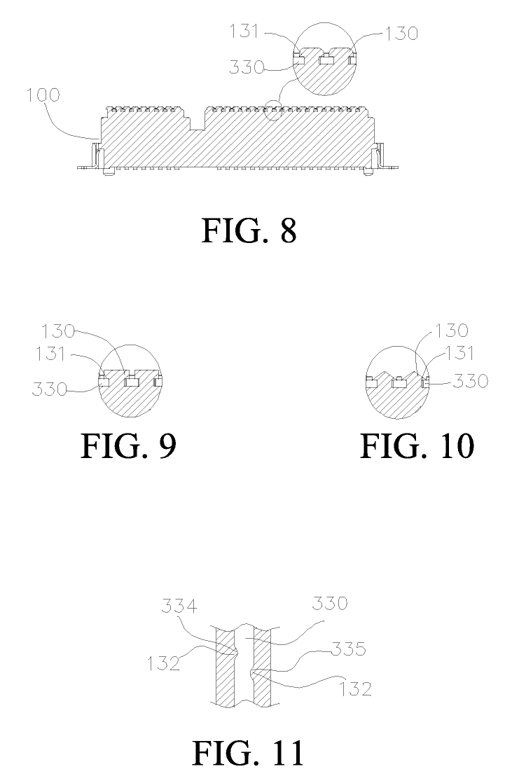

The melt glue device 530 has a melt glue head 531. The melt glue head 531 includes a heating portion 532, and separating blocks 533 at the two sides of the heating portion 532. When fabricating, the front blocking device 510 and the back blocking device 520 are assembled from the two sides of the protruding portion 113 to make the front blocking portion 511 and the back blocking portion 521 near the two ends of the protruding portion 113. The melt glue device 530 is on the predetermined position above the insulating base 100, and the separating blocks 533 correspond to the center position 310 of the terminal. At this time, the front blocking portion 511, the back blocking portion 521, and the separating portions 533 are disposed around the designated area to form a closed glue-blocking device in four directions for making the melted material to flow toward the designated area. Then, the melt glue device 530 is heated, and the melt glue device 530 flows downward to melt the top of the protruding portion 113. The melted material cannot flow forward/backward due to the blocking of the blocking portion 511, 521 in the front end and the back end. The melted material will only flow toward the connecting area of the terminal and the protruding portion 113 and the smaller areas nearby (not flow to the center position of the terminal). Thus, the melt glue fixing structure 130 formed after cooling has stronger fixing effect (the detail is described later.) At the same time, when the melt glue is used, the terminal is pressed by the separating blocks 533 to let the terminal jostle in the passageway of the insulating base 100, as shown in FIG. 6.

As shown in FIGS. 7˜10, the melt glue fixing structure 130 is in a form of cylinder. In the longitudinal direction defined by the terminal, the front end of the terminal is a plane; the back end is a curved surface. In the transverse direction defined by the terminal, a fixing block 131 is above the terminal. The end of the fixing block 131 is not over the center of the terminal. Thus, the melt glue fixing parts can be concentrated at the two sides of the terminal to achieve a better fixing effect.

In this embodiment, the cross-section of the melt glue fixing structure 130 is in a shape of fan. Of course, it can be other forms such as a rectangle, a triangle, and so on (e.g., FIG. 9 and FIG. 10). At the same time, the insulating base 100 vertically extends out of the interval portion 133 at the two sides of the soldering portion 333 to let the soldering portion 333 of the terminal vertically extend out of the insulating base 100. The length of the interval portion 133 is larger than or equals to half of the length of the soldering portion 333. The swaying of the soldering portion 333 can be prevented, and the short circuit of the soldering portion 333 due to the conducting of the solder when soldering can also be prevented.

As shown in FIG. 11, the first hollow portion 334 and the second hollow portion 335 of the two sides of the terminal are interlaced. After the corresponding position of the insulating base is melted, the melted material will flow into the first hollow portion 334 and the second hollow portion 335 to form a prominence that wedges the conducting terminal. The first hollow portion 334 and the second hollow portion 335 can not be oppositely set and thereby prevent that the area of the terminal the hollow portion on is too narrow to be easily snapped.

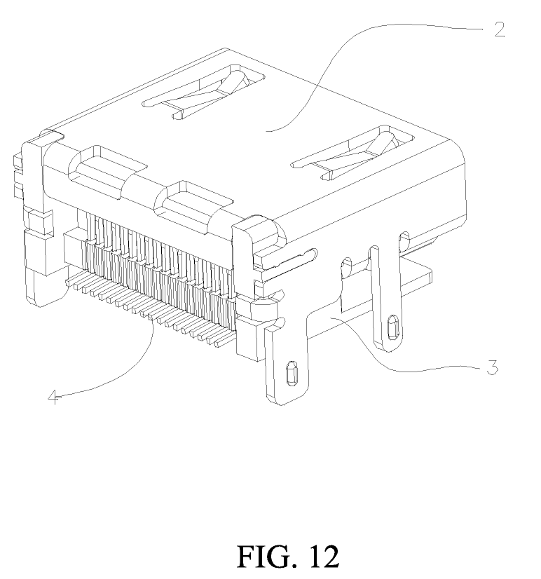

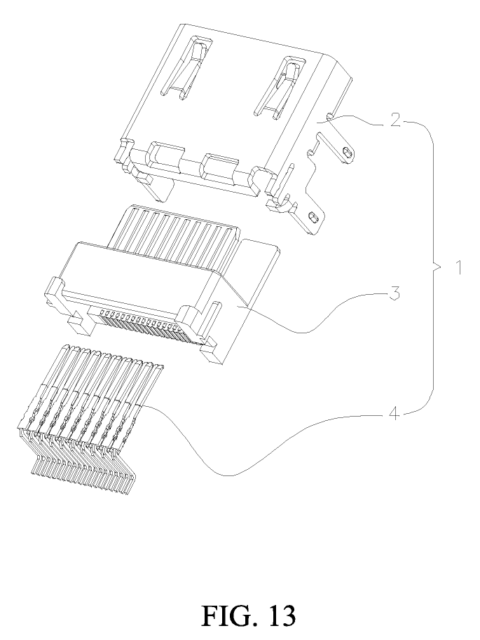

FIGS. 12˜19 show another embodiment of the melt glue fixing method and the electrical connector using the method based on the embodiment of the present invention. The electrical connector includes a metal housing 2, an insulating base 3, and a plurality of terminals 4. The corresponding insulating base 3 is covered by the metal housing 2.

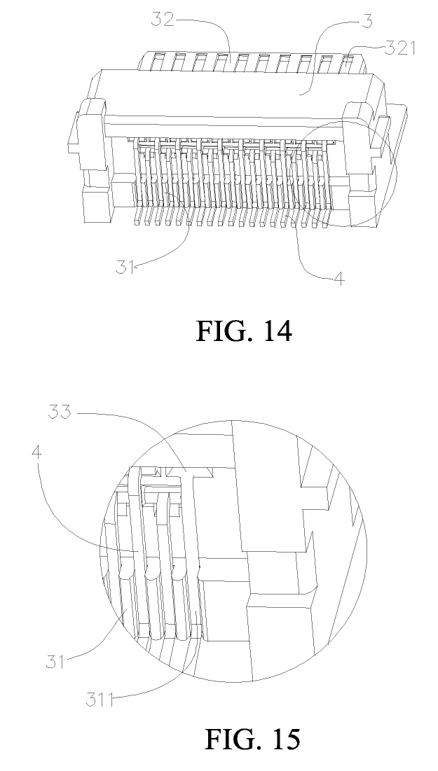

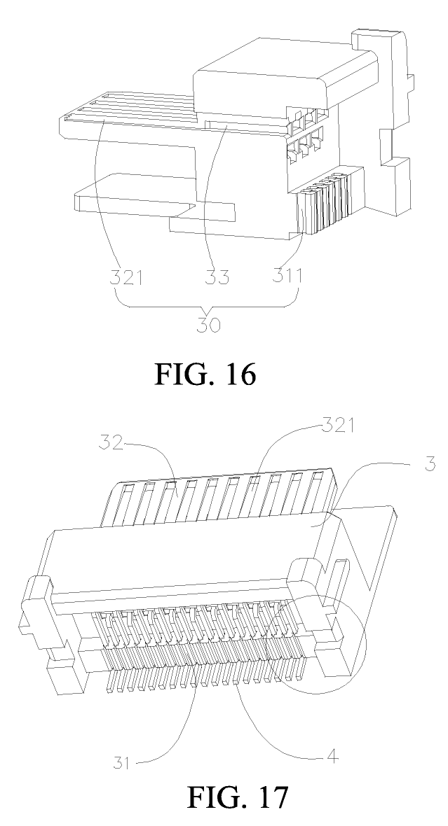

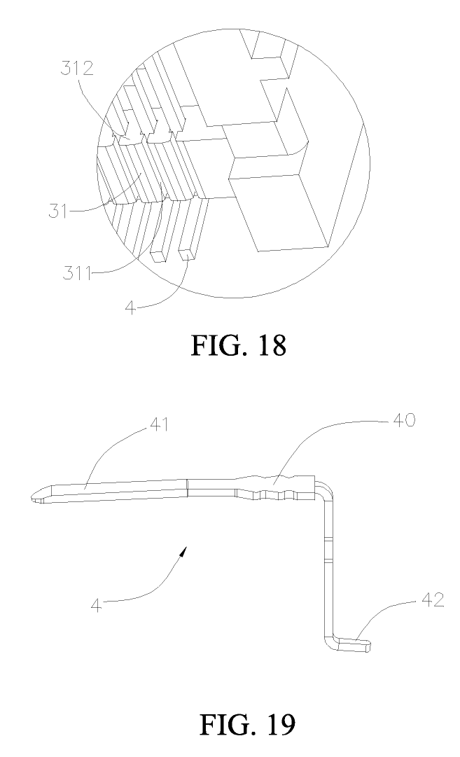

The corresponding insulating base 3 has a terminal positioning rib 31. The height of the terminal positioning rib 31 is higher than the height of the terminal 4. Referring to FIGS. 14˜16, FIGS. 14˜16 are diagrams of the terminal positioning rib 31 of the electrical connector 1 based on the invention before the terminal positioning rib 31 is forced by the external force. The insulating base 3 includes a tongue portion 32. The terminal positioning rib 31 is at one end of the insulating base 3 far away from the tongue portion 32. The insulating base 3 also has a plurality of terminal accepting holes 30. The terminal accepting hole 30 is composed of a groove 321 on the tongue portion 32, an accepting space 311 between the terminal positioning ribs 31, and a through hole 33 between the tongue portion 32 and the terminal positioning rib 31.

Referring FIGS. 17˜18, FIGS. 17˜18 are diagrams of the terminal positioning rib 31 of the electrical connector 1 based on the embodiment of the present invention after the terminal positioning rib 31 is forced by the external force. The positioning rib 31 of the insulating base 3 can form a wedging portion 312 through a melting way. First, the end of the positioning rib 31 is softened by heating or supersonic scanning. Then, the end is pressed by adding an external force to form the wedging portion 312. In this embodiment, the end of the positioning rib 31 is pressed and deformed from the center position to the two sides. Of course, the wedging portion 312 can also be formed through stamping or other modes.

Referring to FIG. 19, the terminal 4 includes a contacting portion 41, a welding portion 42, and a connecting portion 40 connecting the contacting portion 41 and the welding portion 42. The contacting portion 41 is disposed in the groove 321 on the tongue portion 32 of the terminal accepting hole 30. The connecting portion 40 passes through the through hole 33 on the insulating base 100 and is partially in the accepting space 311 between the positioning ribs 31. In this embodiment, the connecting portion 40 is bent to be a right angle. The welding portion 42 is formed by bending and extending from one end of the connecting portion 40, and it can be welded on the circuit board or on other electrical devices (not shown).

The terminal 4 can be first pressed into the insulating base 100, during fabricating. At this time, the connecting portion 40 passes through the through hole 33 on the insulating base 100 and is partially in the accepting space 311 between the positioning ribs 31. The contacting portion 41 is in the groove 321 on the tongue portion 32 of the terminal accepting hole 30. Then, the end of the positioning rib 31 is softened by heating or supersonic scanning. Afterward, the end is pressed by adding an external force to form the wedging portion 312.

Of course, the wedging portion 312 can also be formed through stamping or other modes. The wedging portion 312 is the melt glue fixing structure 130. The flowing direction of the melted material is limited by the blocking portion at two sides, and the separating block which transversely extends alone the terminal and corresponds to the center position of the terminal to form the structure with two planar sides and the fixing block on the top of the terminal is not over the center of the terminal.

The positioning ribs 31 of the electrical connector based on the embodiment of the present invention can also be set as two or more rows and reach the same effect. Thus, the above mentioned electrical connector is also in the protecting scope of the invention.

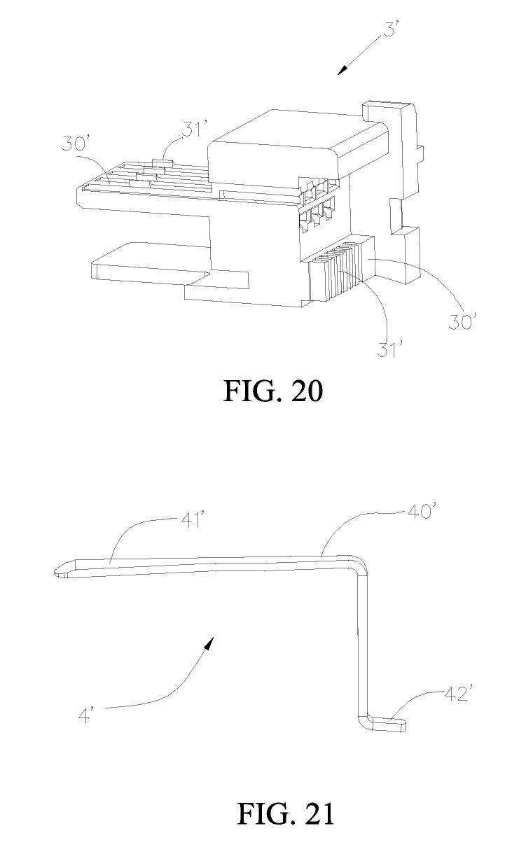

FIG. 20 is a partial diagram of an insulating base 3′ of the electrical connector in the third embodiment based on the present invention. Compared to the above embodiments, the difference is that the insulating base 3′ has two assembling surfaces 30′ for assembling the conducting terminal, and both assembling surfaces 30′ have a positioning rib 31′ for positioning the conducting terminal.

Referring to FIG. 21, a conducting terminal 4′ includes a contacting portion 41′ and a welding portion 42′ welding with a circuit board or other electrical devices (not shown in the figures). A connecting portion 40′ is at the area between the contacting portion 41′ and the welding portion 42′. The connecting portion 40′ is bended to be a right angle. The positioning rib 31′ can be formed a wedging portion for fixing the conducting terminal 4′ through a deformation by an external force (it is not shown in this embodiment because its theory is the same with the first embodiment). During the practicing process, the effect achieved in the above embodiments can also be reached in this embodiment.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A melt glue fixing method, comprising steps of:
providing an insulating base having a plurality of passageways, a protruding portion disposed between the adjacent passageways;
providing a plurality of terminals disposed in the passageways;
providing a glue blocking device for forming a designated area;
heating the protruding portion of the insulating base to form a melted material;
making the melted material flow toward the designated area; and
cooling the melted material to fix the terminals in the passageways of the insulating base.

2. The melt glue fixing method of claim 1, wherein the glue blocking device is disposed around the designated area.

3. The melt glue fixing method of claim 1, wherein the terminal has a hollow portion, and the melted material flows into the hollow portion to form a prominence that wedges the terminal.

4. The melt glue fixing method of claim 1, wherein a first hollow portion and a second hollow portion are at two sides of the terminal, and the first hollow portion and the second hollow portion are interlaced.

5. The melt glue fixing method of claim 1, wherein the glue blocking device comprises a stopping portion extending along a transverse direction defined by the terminal and near two ends of the protruding portion; in a longitudinal direction defined by the terminal, the melted material only flows to the position of the stopping portion.

6. The melt glue fixing method of claim 1, wherein the glue blocking device further comprises a separating block extending along a longitudinal direction defined by the terminal and corresponding to a middle position of the terminal; in a transverse direction defined by the terminal, the melted material only flows toward the connecting area of the terminal and the protruding portion and smaller areas nearby.

7. The melt glue fixing method of claim 6, wherein the separating block is pressed on the terminal during heating.

8. A glue-blocking device for fixing a terminal in an insulating base, the insulating base having a plurality of passageways, a protruding portion disposed between the adjacent passageways, comprising:
a stopping portion extending along a transverse direction defined by the terminal and near two ends of the protruding portion; in a longitudinal direction defined by the terminal, the melted material only flows to the position of the stopping portion; and
a separating block extending along a longitudinal direction defined by the terminal and corresponding to a middle position of the terminal; in a transverse direction defined by the terminal, the melted material only flows toward the connecting area of the terminal and the protruding portion and smaller areas nearby.

9. An electrical connector, comprising an insulating base with a plurality of passageways and at least one terminal accepted in the passageways, wherein the insulating base and the at least one terminal are fixed via a melt glue fixing structure, and the melt glue fixing structure has a shape which can increase the fixing effect.

10. The electrical connector of claim 9, wherein in a longitudinal direction defined by the terminal, two ends of the melt glue fixing structure are respectively a plane, or one end of the melt glue fixing structure is a plane and the other end is a curved surface.

11. The electrical connector of claim 9, wherein in a transverse direction defined by the terminal, the melt glue fixing structure comprises a fixing block above the terminal, and the end of the fixing block is not over the center of the terminal.

12. The electrical connector of claim 9, wherein the cross-section of the melt glue fixing structure is a rectangle, a triangle, or a shape of fan.

13. The electrical connector of claim 9, wherein the metal terminal has a soldering portion connecting to a circuit board, and the insulating base vertically extending out a separating portion on the both sides of the soldering portion.

14. The electrical connector of claim 13, wherein the length of the separating portion is larger than or equal to half of the length of the soldering portion.
